(19) United States
(12) Patent Application Publication
(10) Pub. No.: US 2004/0042499 A1
(43) Pub. Date: Mar. 4, 2004

(54) Time synchronisation

(76) Inventors: Neil Philip Piercy, Royston (GB); Nicholas Dougall Johnson, London (GB)

Correspondence Address: DRINKER BIDDLE & REATH, ONE LOGAN SQUARE, 18TH AND CHERRY STREETS, PHILADELPHIA, PA, 19103-6996, US

(21) Appl. No.: 10/450,341

(22) PCT Filed: Dec. 11, 2001
(86) PCT No.: PCT/GB01/05483

(30) Foreign Application Priority Data
Dec. 12, 2000 (GB) 0030265.3
Dec. 14, 2000 (GB) 0030536.7
Apr. 19, 2001 (GB) 0109658.5

(51) Int. Cl. H04J 3/06

(52) U.S. Cl. 370/503; 370/509

(57) ABSTRACT

A LAN comprises a plurality of nodes (6, 7) connected by LAN cables (14, 15) with conductors (9) dedicated to transmission of timing signals (2) alone or in addition to a power supply for equipment at the node. The conductors (9) may comprise a twisted pair. The conductors (9) may be connected between all ports or may be connected via a wiring box (11). The timing signal may be provided by a source (2) at a LAN connection device (1) or the wiring box (11) or at a node (17).

This invention relates to synchronising clocks and time between nodes across Local Area Networks (LANs), especially for wireless telecommunications systems using LANs to connect one or more radio basestations to the radio basestation controller and the core network.

Traditional wireless telecommunications systems, such as GSM, have typically used synchronous communications links (such as those based on ITU specifications G.703/G.704) to connect the basestations to the core network. As well as providing the data link which carries the network management, control signalling and users' traffic to the basestations, these links have often been used by the basestation to provide an accurate reference clock to which the basestations can lock (using some sort of phase-lock loop) their adjustable local oscillator in order to maintain long term accuracy of the clock. This technique is well known, and allows the local oscillator in the basestation to only be of sufficient accuracy over the short term (typically a few seconds to a few minutes), which allows much smaller, cheaper and lower powered oscillator devices to be used. It relies on the network data links being sourced from a clock which is highly stable and accurate over the long term, which typical networks are, being typically traceable back to a very accurate clock such as a Rubidium standard clock. The short-term inaccuracies of the network data link clocks is “smoothed” by the local oscillator, which in turn is kept accurate over the long term by the network links.

This synchronisation provided by the network data links may give both frequency accuracy (e.g. providing a long-term accurate 10 MHz reference clock), phase accuracy (e.g. alignment of the start of the clock pulses), and also a. longer duration frame timing “tick” (e.g. providing a common 8 kHz tick on multiple pieces of equipment), which can be important in synchronising multiple pieces of equipment to a common “tick” as well as frequency accuracy of the original higher frequency clock which produces this tick.

As the cell sizes of telecommunication systems reduces in order to achieve higher user-capacity per unit area, the number of basestations per unit area also increases. This trend is highlighted by the move towards indoor basestations, with there being several basestations, each with only a few tens to hundreds of metres of range, and there being many such basestations within a single building complex. With this trend it is attractive from a commercial point of view to use packet rather than circuit switched networks, especially computer LAN technology to connect the basestations to the core network, as this allows existing LAN wiring and infrastructure to be used, which is also in such large volume use that it has been highly cost optimised, and is considerably cheaper than the synchronous point to point data links traditionally used. Given the larger numbers of such small coverage basestations, their cost becomes a more important part of the whole system cost than it does for basestations which cover larger areas.

The use of LANs for these links does however mean that the basestations no longer have access to the long term accurate timing signals: the LAN data clocks are generally only produced locally in each node, and by the nature of the requirements for low cost, are relatively inaccurate in the long term compared to the requirements of typical radio basestations which derive their transmitter frequencies from their oscillators.

One possible solution to this problem is to use more accurate local oscillators at each of the basestations, but these would add significant cost, size and power to basestations which are actually required to be smaller, lower powered and cost less than traditional outdoor basestations.

Another approach to the problem is to use a publicly available broadcast source of clock and time for the long-term accuracy at each basestation locally, such as the UK Rugby 200 kHz transmissions or the GPS satellite systems. As well as the extra cost of the receivers for such signals, they suffer disadvantages of requiring a separate antenna, and may not be of use to indoor basestations as they may be located in areas to which the timing radio signals may not reach.

Although there is a method of synchronising computer clocks in both frequency and time using standard network protocols such as Network Time Protocol (NTP), these have been design primarily for synchronising the so-called “wall clock” of computer systems across wide area networks (WAN). NTP is limited in the accuracy with which it can synchronise the clocks at two or more nodes, and the time taken to first achieve synchronisation, by the accuracy of the local oscillators at each node being synchronised, the rate at which they exchange their time information, and the variations in the delays of the packets used to exchange their time information across the network, including the transmission and reception of the packets within the local computer nodes. The accuracy which may be achieved in any given scenario is a complicated function of the above parameters.

If the standard NTP techniques are applied to a LAN environment, the variations in the actual packet transfer times across the LAN may be considerably reduced compared to a WAN environment, but due to the nature of NTP as a software only solution, the time synchronisation accuracies although improved from a WAN environment, are still typically of the order of a millisecond.

The accuracies which are required for the synchronisation of radio based equipment is often several orders of magnitude greater than that currently addressed by NTP, and are in general not constrained by needing a software only solution, but often are constrained to use existing network infrastructure (e.g. cables, network hubs etc).

An object of the invention is to provide an improved accuracy of synchronisation for nodes connected together by an Ethernet LAN.

According to the invention, equipment at a LAN node is synchronised by a timing signal which is transmitted over the LAN via a dedicated conductor of each LAN cable which is not otherwise used for normal LAN signalling.

In one embodiment, spare copper pairs in the standard Ethernet cabling are used to carry additional custom timing signals. The most common LANs in use today are the 10 bT and 100 bT Ethernet LANs. The most common cabling in use today on these LANs is the Category 5 Unshielded Twisted Pair (UTP) cables, which have a 4 pairs of conductors between the two connectors. Standard 10 bT or 100 bT Ethernet however only uses 2 of these 4 pairs.

The invention therefore uses these spare pairs to carry accurate timing information from LAN connection devices to the remote equipment, which would allow both an individual piece of equipment to derive an accurate clock, and to allow multiple pieces of equipment on the same LAN to synchronise their clock and frame structures to each other.

LAN connection devices include hubs, switches, routers, repeaters and other connection devices used in LANs. In the case of a central LAN hub or switch, this is upgraded to include the distribution of the clock by connecting the spare pairs between all the ports. Alternatively, a “wiring box” is provided between the central hub and the LAN cables going to the equipment which needs to be synchronised, and this box just passes the Ethernet signal pairs through, and merges the timing signals on the spare pairs. In either case, the source of the accurate clock may be built into the hub or wiring box, supplied by a separate external input into the hub or wiring box, or provided by one of the pieces of connected network equipment.

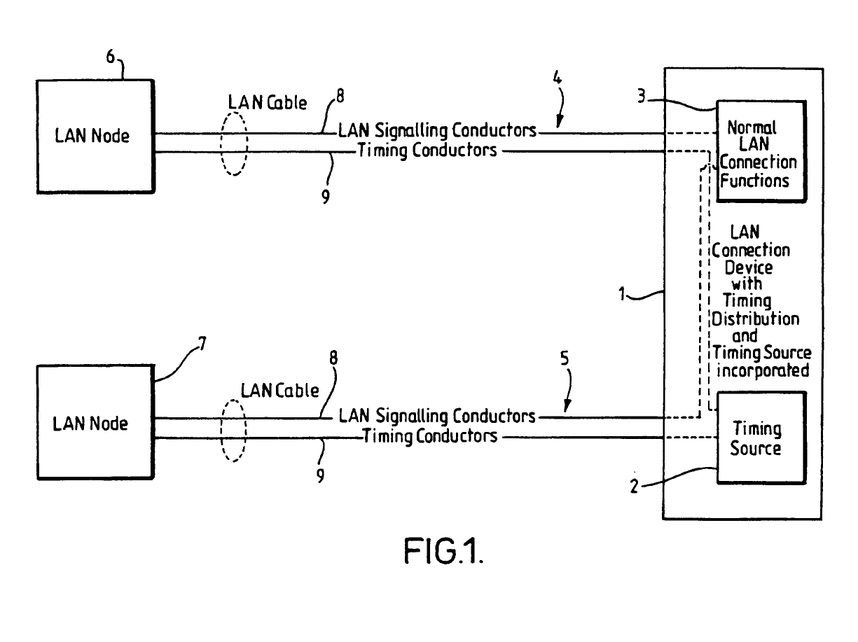

FIG. 1 illustrates an embodiment of the invention in which a LAN connection device 1 incorporates a timing source 2 and normal LAN connection functions 3. The LAN connection device 1 is connected via separate LAN cables 4,5 to two other LAN nodes 6,7. The LAN cables 4,5 comprise UTP cables having two twisted pairs 8 which are connected to be used for normal LAN signalling according to the functions 3, and two twisted pairs which are connected to the timing source 2 to transmit a timing signal to each of the LAN modes 6,7.

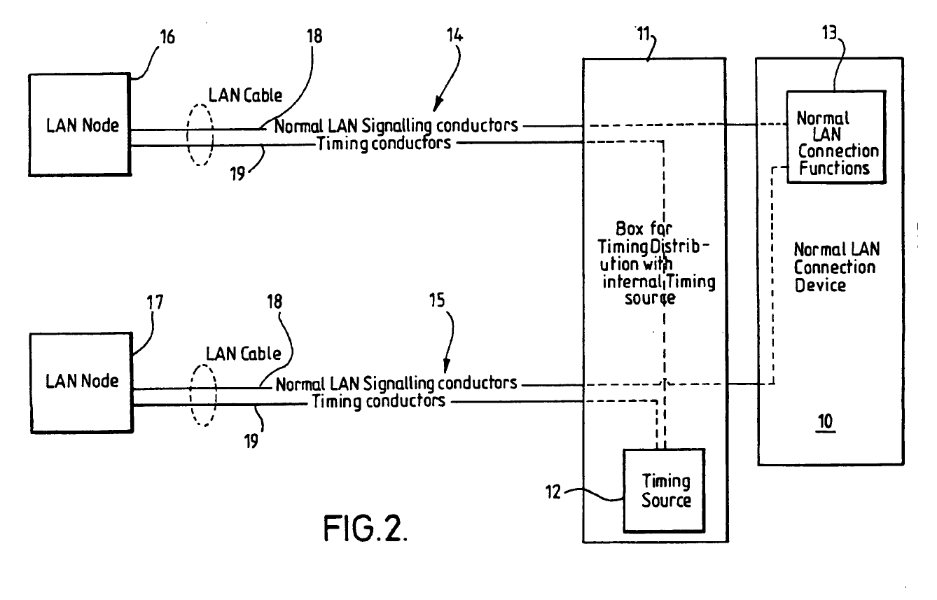

FIG. 2 illustrates an embodiment of the invention in which a LAN connection device 10 is connected via a wiring box 11 and LAN cables 14,15 to each of two LAN nodes 16,17. The LAN cables 14,15 are UTP cables, and the normal LAN connection functions 13 of the LAN connection device 10 are connected via two twisted pairs 18 in each cable 14,15 to a respective LAN node 16,17. Timing signals are generated by a timing source 12 in the wiring box 11 and are transmitted via respective twisted pairs 19 to each LAN node 16,17.

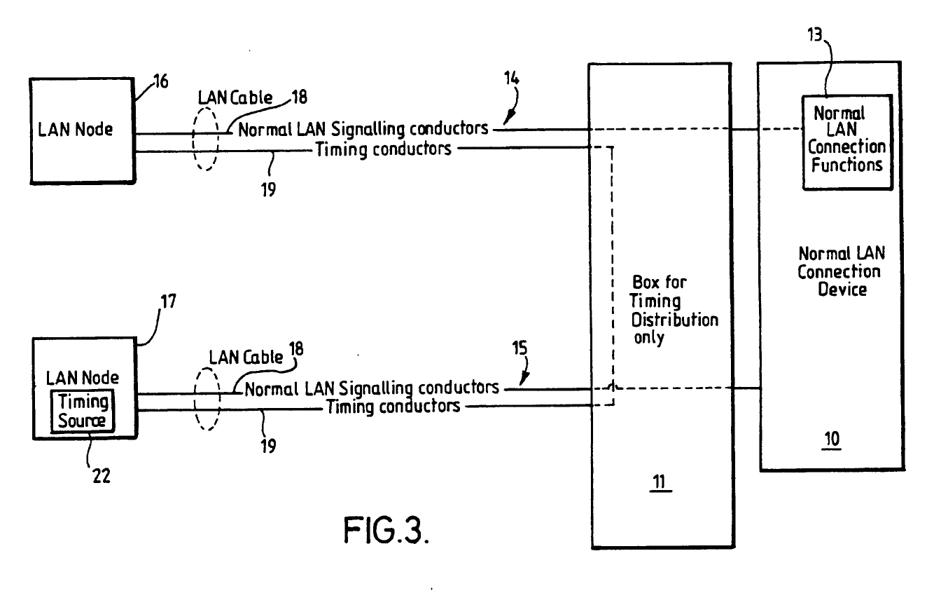

FIG. 3 illustrates an embodiment of the invention similar to FIG. 2 in that a wiring box 11 is provided through which normal LAN functions 13 are transmitted from a LAN connection device 10 to respective LAN nodes 16,17 using twisted pairs 18 of LAN cables 14,15 connected between the LAN nodes 16,17 and the wiring box 11. However, instead of having a timing source incorporated in the wiring box 11, a timing source 22 provided in the LAN node 17 transmits the timing signal via the twisted pairs 19 to the timing box and thence to the LAN node 16.

It will be appreciated that by transmitting a timing signal on a dedicated LAN conductor 9,19, any problems in combining the timing signal with normal LAN signalling on the same conductor are avoided. However, there are current proposals, working groups and standards in preparation (as well as existing non-standard equipment) for using spare twisted pairs to carry low voltage power from the central LAN hub point to remote equipment on the LAN to remove the need for the remote. equipment to have a separate power supply. It will be appreciated that the invention is applicable to a LAN in which the timing signal and power are both transmitted via said dedicated conductor. This would be illustrated in FIG. 2 by replacing the timing source 12 with a timing and power source.

This invention is applicable to any LAN-based equipment which needs high accuracies of synchronisation, and particularly applicable to LAN-based radio basestations which need high accuracy of a local oscillator to generate their radio frequency, and may also require high accuracy of synchronisation of a clock.

1. A LAN comprising a plurality of nodes, each node having equipment connected thereto, said nodes being connected by LAN cables, wherein said equipment is synchronised by a timing signal that is transmitted over the LAN via a dedicated conductor of each LAN cable that is not otherwise used for normal LAN signalling.

2. A LAN according to claim 1, wherein said LAN cables comprise a plurality of twisted pairs of conductors.

3. A LAN according to claim 2, wherein said dedicated conductor comprises a twisted pair of said conductors.

4. A LAN according to any preceding claim, wherein said timing signal is supplied to each dedicated conductor by a LAN connection device.

5. A LAN according to any one of claims 1 to 3, wherein said timing signal is supplied to each dedicated conductor by a wiring box provided between a LAN connection device and the LAN cables.

6. A LAN according to claim 4, wherein said timing signal is generated by said LAN connection device.

7. A LAN according to claim 5, wherein said timing signal is generated by said wiring box.

8. A LAN according to any one of claims 1 to 5, wherein said timing signal is generated by an external timing signal source.

9. A LAN according to any one of claims 1 to 5, wherein said timing signal is generated by at least one of said pieces of equipment.

10. A LAN according to any one of the preceding claims wherein said dedicated conductor is used to transmit said timing signal and power to said equipment.

11. A LAN according to any preceding claim, wherein said equipment comprises a radio basestation of a wireless telecommunications system.

12. A method of synchronising equipment at LAN nodes comprises transmitting a timing signal over the LAN via a dedicated conductor of each LAN cable that is not otherwise used for normal LAN signalling.

13. A method as claimed in claim 12 in which a twisted pair of conductors of the LAN are used to transmit said timing signal.

14. A method according to claim 12 or 13, further comprising supplying said timing signal to said dedicated conductor by a LAN connection device.

15. A method according to any one of claims 12 to 14, further comprising supplying said timing signal to said dedicated conductor by a wiring box provided between a LAN connection device and the LAN cable.

16. A method according to any one of claims 12 to 14, wherein said timing signal is generated by said LAN connection device.

17. A method according to claim 15, wherein said timing signal is generated by said wiring box.

18. A method according to any one of claims 12 to 15, wherein said timing signal is generated by an external timing signal source.

19. A method according to any one of claims 12 to 15, wherein said timing signal is generated by at least one of said pieces of equipment.

20. A method as claimed in any one of claims 12 to 19 wherein said dedicated conductor is used to transmit the timing signal and power to said equipment.
